(19) United States
(12) Patent Application Publication
(10) Pub. No.: US 2003/0084193 A1
(43) Pub. Date: May 1, 2003

(54) Systems and methods for preparing a record of an event based on images from multiple image capture devices

(76) Inventors: Gregory A. Brake, Fort Collins, CO (US); Mark D. Seaman, Greeley, CO (US); Robert E. Chalstrom, Fort Collins, CO (US); Robert D. Thompson, Loveland, CO (US)

Correspondence Address: HEWLETT-PACKARD COMPANY, Intellectual Property Administration, P.O. Box 272400, Fort Collins, CO, 80527-2400, US

(21) Appl. No.: 09/999,304

(22) Filed: Oct. 31, 2001

(51) Int. Cl. G06F 15/16

(52) U.S. Cl. 709/250; 709/231

(57) ABSTRACT

Systems and methods for preparing a record of an event based on images from multiple image capture devices are provided. One embodiment is an image capture device configured to capture images and generate electronic representations of the images. Briefly described, one such image capture device comprises: a network interface device configured for communication with a communication network; and logic associated with the network interface device, the logic configured to establish communication with an image collection server via the communication network, to capture at least one image of an event, and to provide an electronic representation of the at least one image of the event to the communication network for delivery to the image collection server.

### TECHNICAL FIELD

The present invention is generally related to image capture devices and is more particularly related to preparing a record of an event based on images from multiple image captive devices.

### BACKGROUND OF THE INVENTION

Presently, there are a variety of devices configured for capturing an image, such as a still image or a video image, and generating an electronic representation of the image. For instance, video recorders and similar devices are commonly used to capture video images. Digital cameras, image scanners, and other similar devices are commonly used to capture still images. These devices are typically configured to enable the images to be stored as digital images on the device. Typically, these devices also enable users to preview the digital images. Some such devices also enable users to download the digital images to a personal computer where they may be stored, edited, or transmitted via a communications network to other devices configured for connection to the communications network.

Digital cameras, video recorders, and other image capture devices are often used at a specific event, such as, for example, a wedding, where a user desires to document the event by capturing a plurality of different images related to the event. Typically, at such an event, a user captures images for a plurality of specific situations. For instance, at a wedding the user may desire to capture an image of the following people and/or situations: the bride and groom, the bride's family, the groom's family, the wedding party, the wedding procession, the wedding vows, and the toasts, to name a few. However, existing image capture devices require the user to capture the images in an adhoc manner. In such situations the user may be experienced enough to know or to have memorized which situations images are to be captured. Nonetheless, this adhoc process may be problematic in situations when the user does not have experience or when there are additional situations or particular customer requirements for capturing images. For example, the user may fail to capture images for certain situations or may fail to meet the particular customer requirements. In order to reduce errors, a prudent user may write down various instructions for capturing images, such as each of the situations for capturing images and any other specific requirements for capturing images. However, the user may still lose the instructions or may neglect to reference the instructions, which may cause the user to fail to capture images for certain situations or fail to meet particular customer requirements.

Furthermore, there are various events in which a plurality of digital cameras, video recorders, and other types of image capture devices are used to collect images. However, at such events there is little or no collaboration between the image capture devices. Rather, each image capture device collects images and prepares an individual record of the event.

Thus, there is a need in the industry to address these and/or other deficiencies and inadequacies.

### SUMMARY OF THE INVENTION

The present invention provides systems and methods for preparing a record of an event based on images from multiple image capture devices.

One embodiment is an image capture device configured to capture images and generate electronic representations of the images. Briefly described, one such image capture device comprises: a network interface device configured for communication with a communication network; and logic associated with the network interface device, the logic configured to establish communication with an image collection server via the communication network, to capture at least one image of an event, and to provide an electronic representation of the at least one image of the event to the communication network for delivery to the image collection server.

Another embodiment is a method of providing image capture services. Briefly described, one such method comprises the steps of: providing a plurality of image capture devices associated with an event to be recorded, each of the plurality of image capture devices configured to communicate with an image collection server via a communication network; establishing communication between each of the plurality of image capture devices and the image collection server via the communication network; and receiving, via the communication network, electronic representations of a plurality of images from at least one of the plurality of image capture devices, each of the plurality of images associated with the event.

A further embodiment is a server for providing image capture services for an event to be recorded. Briefly described, one such server comprises: a network interface device configured for communication with a communication network; and logic associated with the network interface device, the logic configured to establish communication with a plurality of image capture devices during an event to be recorded, via the communication network, and configured to receive electronic representations of at least one image of the event from one or more of the plurality of image capture devices.

Another embodiment is a system for preparing a record of an event. Briefly described, one such system comprises: a plurality of image capture devices arranged throughout an area associated with the event to be recorded, each of the plurality of image capture devices configured for communication with a communication network and configured to capture one or more images of the event to be recorded and to provide an electronic representation of the one or more images to the communication network; and an image collection server configured for communication with the communication network and configured to receive the electronic representations of the one or more images of the event provided by one of the plurality of image capture devices.

### BRIEF DESCRIPTION OF THE DRAWINGS

The invention can be better understood with reference to the following drawings. The components in the drawings are not necessarily to scale, emphasis instead being placed upon clearly illustrating the principles of the present invention.

Moreover, in the drawings, like reference numerals designate corresponding parts throughout the several views.

FIG. 1 is a schematic diagram of one of a number of possible embodiments of a system for preparing a record of an event based on images from multiple image capture devices according to the teachings of the present invention.

FIG. 2 is a flowchart of the general operation of the system of FIG. 1.

FIG. 3 is a schematic diagram of one of a number of possible embodiments of the image capture device of FIG. 1.

FIG. 4 is a flow diagram illustrating the architecture, operation, and/or functionality of one of a number of possible embodiments of the individual event record module of the image capture device of FIG. 3.

FIG. 5 is a schematic diagram of one of a number of possible embodiments of the image collection server of FIG. 1.

FIG. 6 is a flow diagram illustrating the architecture, operation, and/or functionality of one of a number of possible embodiments of the individual event record aggregation module of the image collection server of FIG. 5.

### DETAILED DESCRIPTION OF A PREFERRED EMBODIMENT

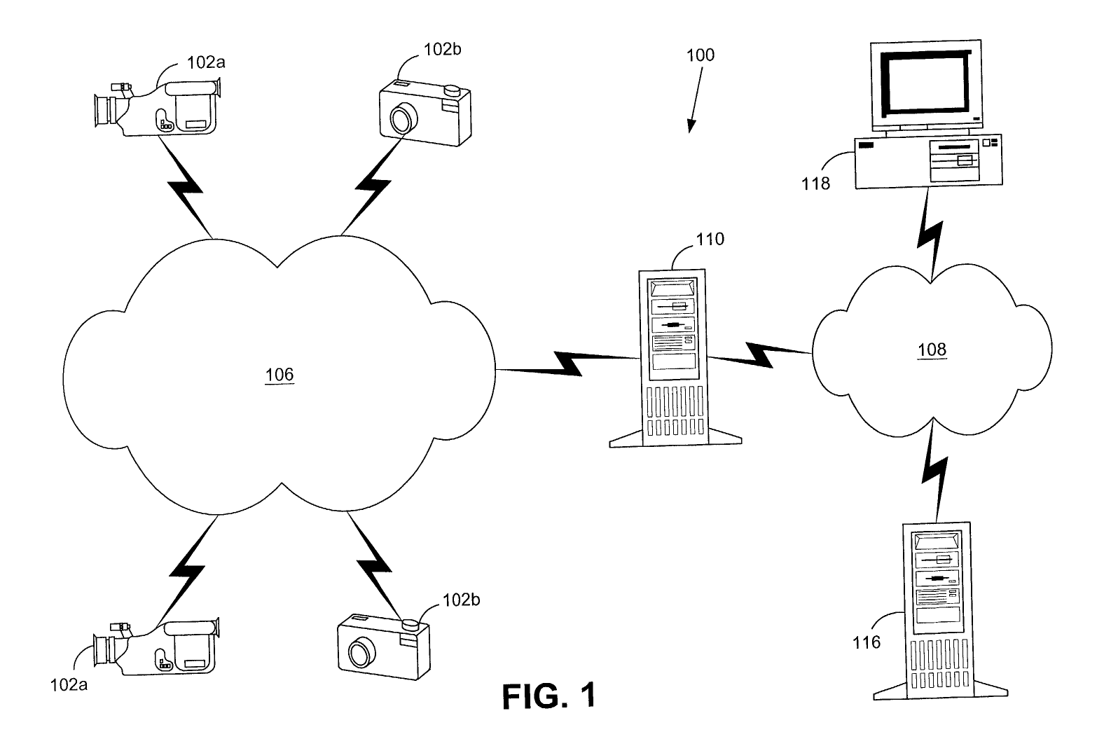

FIG. 1 illustrates a system 100 for preparing a record of an event based on images, such as still images or video images, captured by a plurality of image capture devices 102. System 100 may comprise various image capture devices 102 in communication with an image collection server 110 via a communication network 106. Image capture devices 102 are associated with an event to be recorded. Image capture devices 102 may be arranged throughout an area associated with the event to be recorded. One of ordinary skill in the art will appreciate that the area in which image capture devices 102 are arranged need not be contiguous. For example, the event to be recorded may take place in more than one location. In this situation, each location includes a collection of image capture devices 102 in communication with an image collection server 110. Even where the event takes place in multiple locations, system 100 may employ only one image collection server 110. However, in other embodiments, each collection of image capture devices 102 may communicate with a different image collection server 110. In these situations, the image collection servers 110 may be interconnected via another communication network. Alternatively, each image collection server 110 may communicate with a central image collection server 110.

System 100 may further comprise an application server 116 in communication with image collection server 110 via communication network 108. Communication networks 106 and 108 may be any type or combination of communication networks that employ any network topology, transmission medium, or network protocol. For example, communication network 106 and 108 may be an intranet, a local area network (LAN), a metropolitan area network (MAN), a wide area network (WAN), any public or private packet-switched or other data network, including the Internet, circuit-switched networks, such as the public switched telephone network (PSTN), wireless networks, or any other desired communications infrastructure.

In a number of many possible embodiments, communication network 106 is a local area network. One of ordinary skill in the art will appreciate that because image capture devices 102 are associated with a particular event that is to be recorded, there may be situations in which a local area network is desirable. Depending on the surrounding details of the event to be recorded, the precise configuration of communication network 106 may be changed. For example, the event to be recorded may be located in an environment having a preexisting local area network. In such situations, communication network 106 may be the preexisting local area network. In other situations, the event to be recorded may be in a remote location. In these situations, system 100 may be configured such that communication network 106 is a wireless network and image capture devices 102 are configured to communicate wirelessly with image collection server 110. Again, the configuration of communication network 106 is not integral and one of ordinary skill in the art will appreciate that various other implementations may be used depending on a variety of circumstances and system requirements. Furthermore, in a number of many possible embodiments, communication network 108 may be a wide area network, such as the Internet.

Image capture devices 102 may be any of a variety of devices configured for capturing images, such as still images and video images, and also configured for communication with communication network 106. For example, as illustrated in FIG. 1, image capture devices 102 may be a video recorder 102a configured for communication with communications network 106, a camera 102a, such as a digital camera, configured for communication with communication network 106, an image scanner configured for communication with communication network 106, or any other similar device configured for capturing digital still images and/or video images and also configured for communication with communication network 106. Image capture devices 102 may be mobile devices configured to communicate wirelessly with communication network 106. Image capture devices 102 may also be fixed devices. For example, image capture devices 102 may be preinstalled into a particular event venue.

As stated above, the precise configuration of communication networks 106 and 108, image capture devices 102, image collection server 110, and application server 116 is not critical. The important aspect is that image capture devices 102 are configured to capture images, such as still images and video, of an event to be recorded. Image collection server 110 and image capture devices 102 are preferably configured such that electronic representations of the captured images of the event may be provided from each image capture device 102 to image collection server 110 via communication network 106. Image collection server 110 and application server 116 may be configured such that application server 116 receives the electronic representations of the captured images of the event via communication network 108 and application server 116 generates a presentation of the event based on the electronic representations of the captured images of the event. Any of a variety of computing devices 118 may communicate with application server 116 and/or image collection server 110 via communication network 108. In this manner, computing devices 118 may access the electronic representations of the captured images from image collection server 110 and application server 116. Computing devices 118 may also access the presentation of the event generated by application server 116.

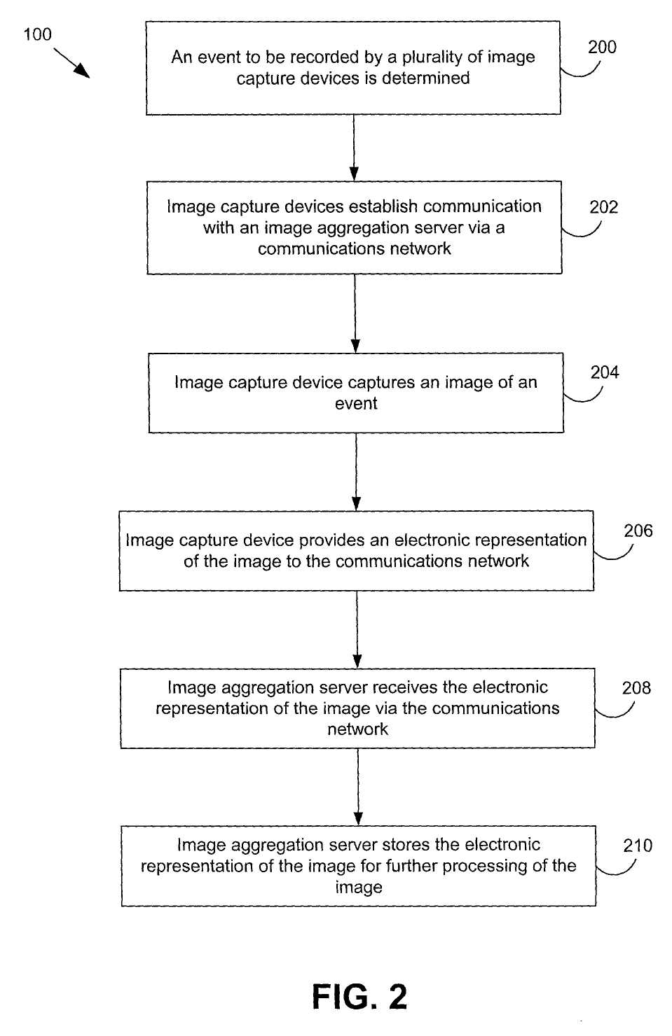

FIG. 2 is a flow chart illustrating the general operation of the embodiment of system 100 illustrated in FIG. 1 for preparing a record of an event based on images from a plurality of image capture devices 102. At block 200, an event to be recorded by a plurality of image capture devices 102 may be determined. The types of events and specific details of the event are not critical. In fact, system 100 may be implemented for recording any desirable event. As stated above, the precise configuration of system 100 may be changed in order to accommodate various types of events. For instance, where the event occurs in more than one location, system 100 may employ more than one collection of image capture devices 102, more than one image collection server 110, and more than one communication network 106. Regardless the specific event to be recorded, a plurality of image capture devices 102 may be arranged throughout an area associated with the event. The plurality of image capture devices 102 may be configured to communicate with image collection server 110 via communication network 106.

At block 202, image capture devices 102 may establish communication with image collection server 110 via communication network 106. Image capture devices 102 may establish communication with image collection server 110 in a variety of ways and using a variety of communication protocols depending on the precise configuration of system 100. For example, in various embodiments where communication network 106 is a wireless communication network, image capture devices 102 may automatically initiate and establish communication with image collection server 110. In other embodiments, such as where communication network 106 is not wireless, a user operating the image capture device 102 may initiate communication with image collection server 110 via a user interface device associated with the image capture device 102. Furthermore, as stated above, system 100 may be implemented in situations where image capture devices 102, image collection server 110, and communication network 106 are preinstalled at a particular event venue. In these situations, communication between image capture devices 102 and communication network 106 may be predetermined.

At block 204, at least one image capture device 102 may capture at least one image of the event. At block 206, the image capture devices 102 that have captured an image of the event may provide an electronic representation of the image to communication network 106 for delivery to image collection server 110. Image capture devices 102 may provide additional information to communication network 106. One of ordinary skill in the art will appreciate that it may be desirable for image capture devices 102 to provide a variety of other types of information to communication network 106 in order to prepare a record of the event. Image capture devices 102 may provide a variety of types of information other than the electronic representations of the images of the event. For example, image capture devices 102 may provide information related to a captured image, such as details about the subject matter of, or circumstances surrounding, the image and/or meta-data associated with the image, as disclosed in U.S. patent application Ser. No. ______, entitled “Systems and Methods for Generating Digital Images Having Image Meta-Data Combined with the Image Data” and filed Oct. 30, 2001 (HP Docket No. 10008306-1), which is hereby incorporated by reference in its entirety.

Furthermore, image capture devices 102 may provide information related to the type of image capture device 102 and information related to the user operating the image capture device 102. In this manner, image collection server 110 may be configured to identify specific image capture devices 102 and/or specific users of image capture devices 102. One of ordinary skill in the art will appreciate that this information may be desirable in generating a presentation based on the captured images. Image capture devices 102 may also provide information related to the event for which the images are captured. In this manner, image capture devices 102 may be used to capture images of multiple events at the same time. By sending information about the specific event for which the image is being captured, image collection server 110 may be configured to sort images captured for multiple events.

At block 208, image collection server 110 may receive the electronic representations of the images provided by the image capture devices 102 via communication network 106. Image collection server 110 may also receive any additional information provided by the image capture devices 102 as described above with respect to block 206. At block 210, image collection server 110 may store the electronic representations of the image for further processing. One of ordinary skill in the art will appreciate that image collection server 110 may be configured to perform this processing. For example, as stated above and described in detail below, image collection server 110 may be configured to generate a presentation of the event based on the electronic representations of the captured images. Alternatively, further processing of the electronic representations of the captured images need not be performed by image collection server 110. For example, referring again to FIG. 1, image collection server 110 may communicate with application server 116 via communication network 108. Thus, image collection server 110 may provide the electronic representations of the captured images to application server 118 where the presentation of the event may be generated.

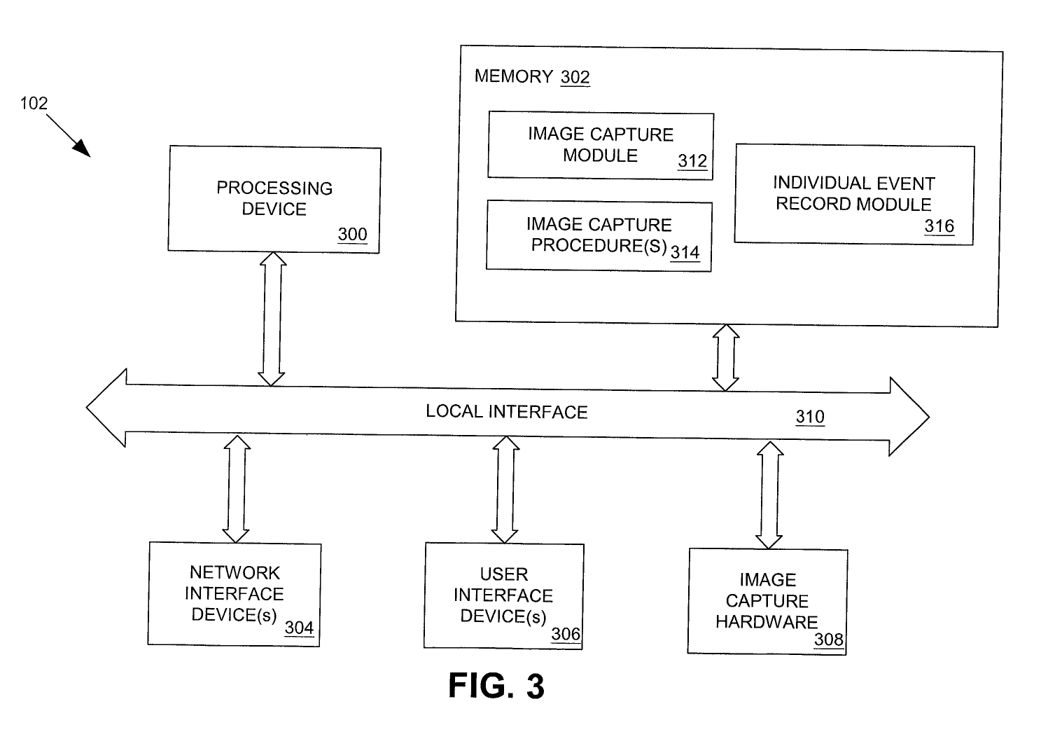

As stated above, image capture devices 102 may be any of a variety of devices configured for capturing images, such as still images and video images, and also configured for communication with communications network 106. FIG. 3 illustrates a schematic diagram of one of a number of possible embodiments of image capture device 102 in system 100 of FIG. 1 according to the teachings of the present invention. Image capture device 102 may comprise a processing device 300, memory 302, at least one network interface device 304, at least one user interface device 306, and image capture hardware 308 interconnected via local interface 310. Memory 302 may comprise an image capture module 312, at least one image capture procedure 314, and individual event record module 316.

Local interface 310 may be, for example but not limited to, at least one bus or other wired or wireless connection, as known in the art. Local interface 310 may comprise additional elements, which are omitted for simplicity, such as controllers, buffers (caches), drivers, repeaters, and receivers, to enable communications. Further, local interface 310 may include address, control, and/or data connections to enable appropriate communications among processing device 300, memory 302, network interface devices 304, user interface devices 306, and image capture hardware 308.

Memory 302 may include any one or combination of volatile memory elements and nonvolatile memory elements. Memory 302 may incorporate electronic, magnetic, optical, and/or other types of storage media. Memory 302 may also have a distributed architecture, where various components are situated remote from one another, but may be accessed by the processing device 300. Memory 302 may comprise image capture module 312, at least one image capture procedure 314, and individual event record module 316.

Processing device 300 may be a hardware device for executing software located in memory 302. Processing device 300 may be any custom-made or commercially-available processor, a central processing unit (CPU), a semiconductor based microprocessor (in the form of a microchip or chip set), a macroprocessor, or generally any device for executing software instructions.

User interface device(s) 306 may comprise at least one function key with which the operation of the image capture device 102 can be controlled by a user. User interface device(s) 306 may also comprise a liquid crystal display (LCD) or other similar display for facilitating the interaction between a user and image capture device 102. Furthermore, user interface device(s) 306 may comprise a display for previewing the images captured by the device. Image capture hardware 308 may comprise the components for capturing an image, such as a still image or video image, and generating an electronic representation of the image. As understood by one of ordinary skill in the art, image capture device 102 may further comprise any of a number of other components not illustrated in FIG. 3.

Network interface device(s) 308 may be configured to facilitate communication with image collection server 110 or any other device connected to communication network 106. Thus, network interface device(s) 308 may comprise a data transmitting device and a data receiving device for providing wired and/or wireless communication between image capture device 102 and communication network 106.

Image capture module 312, image capture procedures 314, and individual event record module 316 may be implemented in hardware, software, firmware, or a combination thereof. As illustrated in FIG. 3, in one of a number of possible embodiments, image capture module 312, image capture procedures 314, and individual event record module 316 are implemented in software or firmware that is stored in memory 302 and that is executed by processing device 300 or any other suitable instruction execution system. If implemented in hardware, as in alternative embodiments, image capture module 312, image capture procedures 314, and individual event record module 316 may be implemented with any or a combination of the following technologies, which are all well-known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

Image capture module 312 comprises logic configured to cooperate with image capture hardware 308 and to, for example, capture an image, generate an electronic representation of the captured image, and store the electronic representation of the captured image. Image capture module 312 may also comprise logic configured for displaying and/or manipulating the electronic representation of a captured image, as well as other logic for performing any of a variety of other functions associated with image capture device 102.

An image capture procedure 314 generally comprises a list of predefined situations for capturing an image at the event to be recorded, which may be implemented by image capture device 102. In operation, image capture device 102 preferably implements image capture procedure 314 by presenting a list of predefined situations for capturing an image on user interface device 306 associated with image capture device 102. A user that is operating image capture device 102 may view the list of predefined situations for capturing an image. In this manner, image capture procedure 314 provides a user of image capture device 102 a scripted guide for capturing particular images at a specific event.

Image capture procedure 314 may be configured as disclosed in U.S. patent application Ser. No. ______, entitled “Systems and Methods for Generating an Implementing an Image Capture Procedure for an Image Capture Device” and filed Oct. 31, 2001 (HP Docket No.: 10008299-1), which is hereby incorporated by reference in its entirety. For example, image capture procedure 314 may include information related to a specific event for capturing a plurality of images. The event may be related to any situation in which it is desirable to capture a plurality of images, such as still images or video. Image capture procedure 314 may include information related to a plurality of predefined situations for capturing an image. Each of the plurality of predefined situations for capturing an image are associated with the event. The plurality of predefined situations may comprise information identifying any type of situation and/or person(s) related to the event for which an image is to be captured. Furthermore, each predefined situation may have at least one predefined image capture parameter associated with the predefined situation for capturing an image. The predefined image capture parameters may comprise further details about the predefined situations for capturing an image. It should be noted that image capture device 102 need not include image capture procedures 314. Nonetheless, image capture procedures 314 may be included in image capture device 102 to enable a user of image capture device 102 to view a scripted guide for capturing particular images at the event.

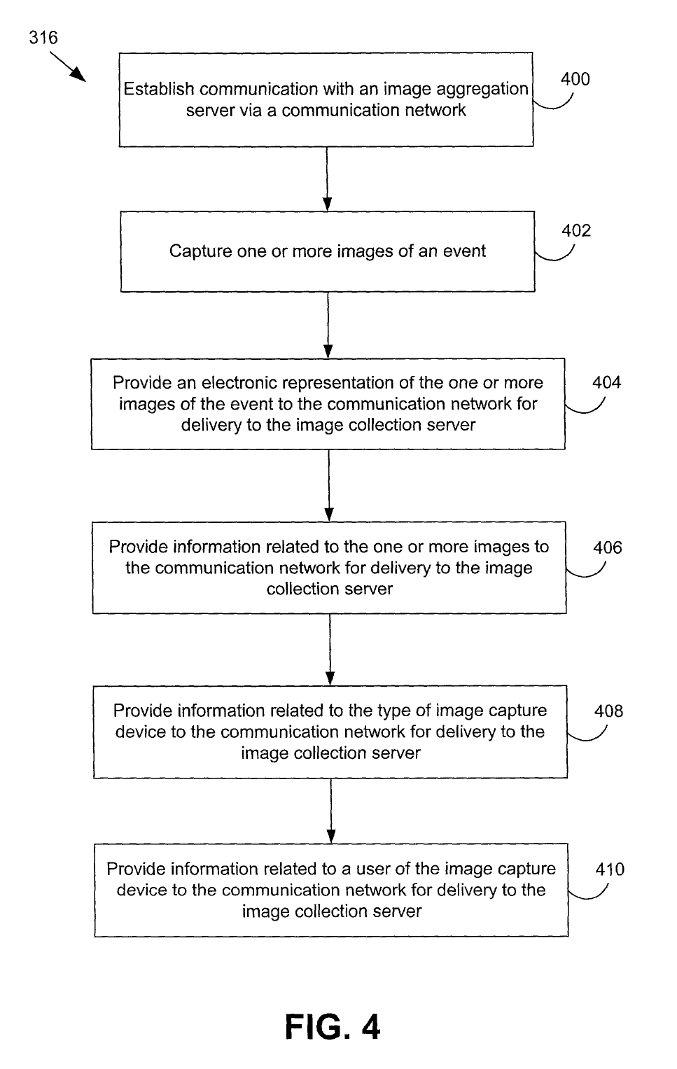

FIG. 4 is a flow chart illustrating the architecture, operation, and/or functionality of one of a number of possible embodiments of individual event record module 316 of image capture device 102 of FIG. 3. Individual event record module 316 comprises the logic that enables an image capture device 102 to interact with image collection server 110. In this manner, individual event record module 316 enables system 100 to prepare a record of an event based on images captured from a plurality of image capture devices 102.

At block 400, image capture device 102 establishes communication with image collection server 110 via communication network 106. As stated above with respect to the general operation of system 100, image capture device 102 may establish communication with image collection server 110 in a variety of ways and using a variety of communication protocols depending on the precise configuration of system 100. At block 402, image capture device 102 may capture at least one image of the event. Individual event record module 316 may control this functionality by merely calling image capture module 312. One of ordinary skill in the art will appreciate that the functionality of image capture module 312 may also be implemented in individual event record module 316.

Regardless the specific implementation, at block 404, image capture device 102 may provide an electronic representation of captured images to communication network 106 for delivery to image collection server 110. This may occur in a variety of ways. For example, the electronic representations of captured images may be provided to communication network 106 after an image is captured. In other embodiments of individual event record module 316, the electronic representations of the captured images may be provided to communication network 106 when initiated by a user of image capture device 102 or requested by image collection server 110. In further embodiments, the electronic representations of captured images may be provided to communication network 106 at a predefined time determined by image capture device 102. One of ordinary skill in the art will appreciate that the manner and/or the timing with which the electronic representations of the capture images are provided to communication network 106 is not integral. Rather, this may be performed in a variety of alternative ways.

As stated above with respect to FIG. 2, image capture devices 102 may provide additional information to communication network 106. At blocks 406, 408, and 410, image capture device 102 may provide a variety of other types of information to communication network 106 in order to prepare a record of the event. For example, at block 406, image capture device 102 may provide information related to a captured image, such as details about the subject matter of, or circumstances surrounding, the image and/or meta-data associated with the image. At block 408, image capture device 102 may provide information related to the type of image capture device 102. At block 410, image capture device 102 may provide information related to a user of image capture device 102. One of ordinary skill in the art will appreciate that various other types of information may be provided to communication network 106. The important aspect of individual event record 316 is that the images of the event that are captured by image capture device 102 are provided to communication network 106 for delivery to image collection server 110.

Image capture module 312, image capture procedures 314, and individual event record module 316, which each comprise a listing of executable instructions for implementing logical functions, can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can contain, store, communicate, propagate, or transport the program for use by or in connection with the instruction execution system, apparatus, or device. The computer-readable medium can be, for example but not limited to, an electronic, magnetic, optical, electromagnetic, infrared, or semiconductor system, apparatus, device, or propagation medium. Note that the computer-readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory.

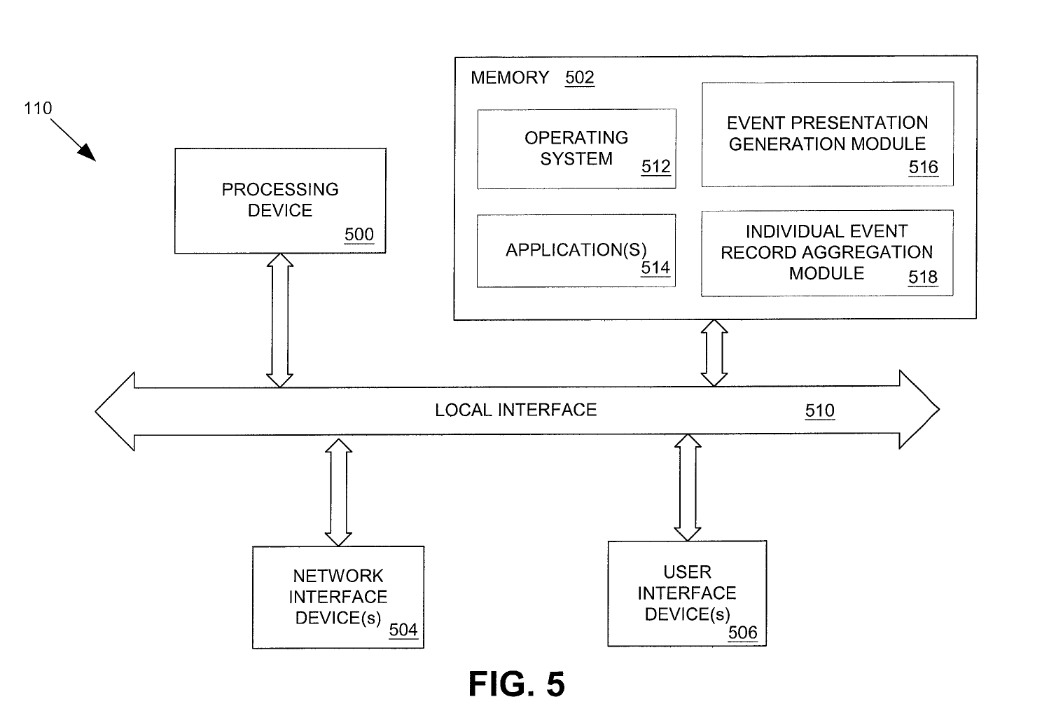

FIG. 5 illustrates a schematic diagram of one of a number of embodiments of an image collection server 110 for preparing a record of an event based on a plurality of image capture devices 102 in communication with image collection server 110 via communication network 106. Image collection server 110 may comprise a processing device 500, memory 502, at least one network interface device 504, and at least one user interface device 506 interconnected via local interface 510.

Local interface 510 may be, for example but not limited to, at least one bus or other wired or wireless connection, as known in the art. Local interface 510 may comprise additional elements, which are omitted for simplicity, such as controllers, buffers (caches), drivers, repeaters, and receivers, to enable communications. Further, local interface 510 may include address, control, and/or data connections to enable appropriate communications among processing device 500, memory 502, network interface devices 504, and user interface devices 506.

Memory 502 may include any at least one combination of volatile memory elements and nonvolatile memory elements. Memory 502 may incorporate electronic, magnetic, optical, and/or other types of storage media. Memory 502 may also have a distributed architecture, where various components are situated remote from one another, but may be accessed by the processing device 1000. Memory 502 may comprise an operating system 512, at least one software application 514, an event presentation generation module 516, and an individual event record aggregation module 518.

Processing device 500 may be a hardware device for executing software located in memory 502. Processing device 500 may be any custom-made or commercially-available processor, a central processing unit (CPU), a semiconductor based microprocessor (in the form of a microchip or chip set), a macroprocessor, or generally any device for executing software instructions.

One network interface device 504 may be configured to facilitate communication with image capture devices 102 via communication network 106. Another network interface device 504 may be configured to facilitate communication with application server 116 and/or computing device 118 via communication network 108. Thus, network interface device(s) 504 may comprise a data transmitting device and a data receiving device for providing wired and/or wireless communication between image capture devices 102, computing devices 118, and application server 116 and communication networks 106 and 108.

Individual event record aggregation module 518 and event presentation generation module 516 may be implemented in hardware, software, firmware, or a combination thereof. As illustrated in FIG. 5, in one of a number of possible embodiments, individual event record aggregation module 518 and event presentation generation module 516 are implemented in software or firmware that is stored in memory 502 and that is executed by processing device 500 or any other suitable instruction execution system. If implemented in hardware, as in alternative embodiments, individual event record aggregation module 518 and event presentation generation module 516 may be implemented with any or a combination of the following technologies, which are all well-known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

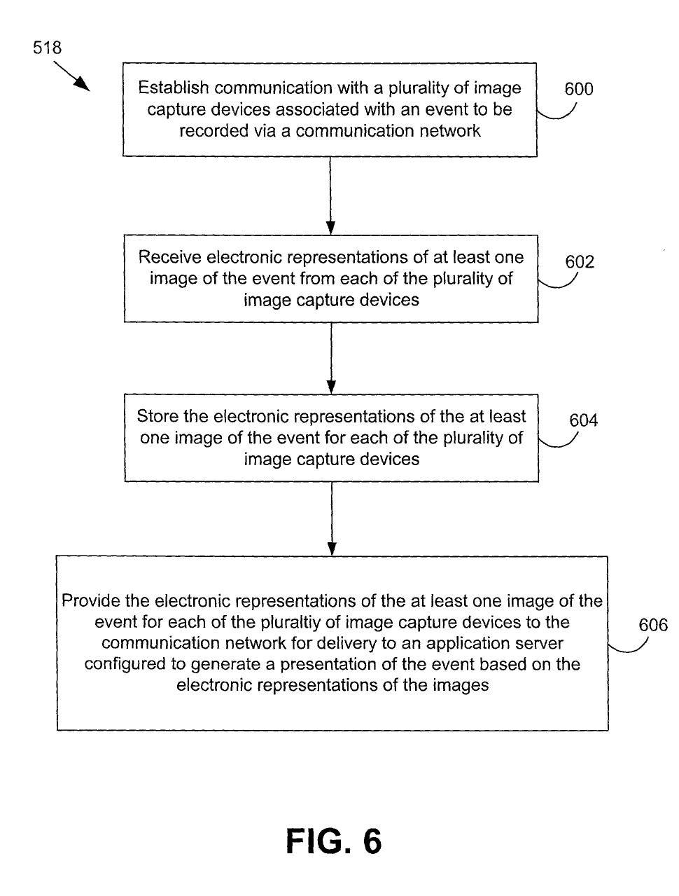

FIG. 6 is a flow diagram illustrating the architecture, operation, and/or functionality of one of a number of possible embodiments of individual event record aggregation module 518 of FIG. 5. Individual event record aggregation module 518 comprises the logic associated with image collection server 110 for preparing a record of an event based on images from multiple image capture devices 102. At block 600, image collection server 110 establishes communication with at least one image capture device 102. As stated above with respect to image capture device 102, image collection server 110 may establish communication with an image capture device in a variety of ways and using a variety of communication protocols depending on the precise configuration of system 100.

At block 602, image collection server 110 may receive from communication network 106 an electronic representation of an image captured by an image capture device 102. This functionality may be implemented in any of the ways described above with respect to individual event record module 316 (FIGS. 3 and 4). At block 604, image collection server 110 may store the electronic representations of the captured images. At block 606, image collection server 110 may provide the electronic representations of the captured images to communication network 108 for delivery to an application server 116.

One of ordinary skill in the art will appreciate that image collection server 110 may include additional logic, such as event presentation generation module 516 (FIG. 5), which is configured to process the electronic representations of the images captured by image capture devices 102 and prepare a presentation of the event. For example, as stated above, image collection server 110 may be configured to generate a presentation of the event based on the electronic representations of the captured images. Event presentation generation module 516 may generate a slideshow comprising a collection of still images, a CD-ROM presentation, a digital video disk (DVD) presentation, a VHS presentation, or any other presentation containing still images and/or video images that may also contain audio content. As shown in FIG. 1, in alternative embodiments, image collection server 110 may provide the electronic representations of the captured images to an application server 116 via communication network 108, which is configured to generate the presentation of the event.

Event presentation generation module 516 and individual event record aggregation module 518, which each comprise an ordered listing of executable instructions for implementing logical functions, can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can contain, store, communicate, propagate, or transport the program for use by or in connection with the instruction execution system, apparatus, or device. The computer-readable medium can be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection (electronic) having at least one wire, a portable computer diskette (magnetic), a random access memory (RAM) (electronic), a read-only memory (ROM) (electronic), an erasable programmable read-only memory (EPROM or Flash memory) (electronic), an optical fiber (optical), and a portable compact disc read-only memory (CDROM) (optical). Note that the computer-readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory.

Therefore, having thus described the invention, at least the following is claimed:

1. An image capture device configured to capture images and generate electronic representations of the images, the image capture device comprising:
a network interface device configured for communication with a communication network; and
logic associated with the network interface device, the logic configured to establish communication with an image collection server via the communication network, to capture at least one image of an event, and to provide an electronic representation of the at least one image of the event to the communication network for delivery to the image collection server.

2. The image capture device of claim 1, wherein the logic is software stored in a memory and further comprising a processor device for executing the logic.

3. The image capture device of claim 1, wherein the communication network is one from the group comprising a local area network, a wide area network and a wireless network.

4. The image capture device of claim 1, wherein the logic is further configured to provide information related to the at least one image to the communication network for delivery to the image collection server.

5. The image capture device of claim 1, wherein the logic is further configured to provide information related to the type of image capture device.

6. The image capture device of claim 1, wherein the logic is further configured to provide information related to a user operating the image capture device.

7. The image capture device of claim 1, wherein the logic is further configured to provide information related to the event for which the at least one image are captured.

8. A method of providing image capture services, the method comprising the steps of:
providing a plurality of image capture devices associated with an event to be recorded, each of the plurality of image capture devices configured to communicate with an image collection server via a communication network;
establishing communication between each of the plurality of image capture devices and the image collection server via the communication network; and
receiving, via the communication network, electronic representations of a plurality of images from at least one of the plurality of image capture devices, each of the plurality of images associated with the event.

9. The method of claim 8, wherein receiving electronic representations of the plurality of images further comprises receiving information related to at least one of the following: the plurality of images, the image capture devices, a user operating one of the image capture devices, and the event for which the plurality of images are captured.

10. The method of claim 8, further comprising storing the electronic representations of the plurality of images in the image collection server.

11. The method of claim 10, further comprising generating a presentation of the event based on the electronic representations of the plurality of images.

12. The method of claim 11, further comprising providing the electronic representations of the plurality of images to an application server via the Internet, the application server configured to generate a presentation of the event based on the electronic representations of the plurality of images.

13. A server for providing image capture services for an event to be recorded, comprising:
a network interface device configured for communication with a communication network; and
logic associated with the network interface device, the logic configured to establish communication with a plurality of image capture devices during an event to be recorded, via the communication network, and configured to receive electronic representations of at least one image of the event from one or more of the plurality of image capture devices.

14. The server of claim 13, wherein the communication network is one from the group comprising a local area network, a metropolitan area network, the Internet, and an intranet.

15. The server of claim 13, wherein the logic is software stored in a memory and further comprising a processor device for executing the logic.

16. The server of claim 13, wherein the communication network is a wireless network.

17. The server of claim 13, wherein the logic is further configured to receive information related to at least one of the following: the at least one image of the event, the plurality of image capture devices, a user operating one of the image capture devices, and the event for which the at least one image are captured.

18. The server of claim 13, further comprising memory for storing the electronic representations of the at least one image of the event.

19. The server of claim 13, further comprising a software application configured to generate a presentation of the event based on the electronic representations of the at least one image.

20. A system for preparing a record of an event, the system comprising:
a plurality of image capture devices arranged throughout an area associated with the event to be recorded, each of the plurality of image capture devices configured for communication with a communication network and configured to capture one or more images of the event to be recorded and to provide an electronic representation of the one or more images to the communication network; and
an image collection server configured for communication with the communication network and configured to receive the electronic representations of the one or more images of the event provided by one of the plurality of image capture devices.

21. The system of claim 20, wherein the image collection server is further 2 configured to receive from one of the plurality of image capture devices information related to at least one of the following: the at least one captured image, the image capture device, a user operating the image capture device, and the event for which the plurality of images are captured.

22. The system of claim 20, wherein the image collection server is further configured to generate a presentation of the event based on the electronic representations of the plurality of images received from the image capture devices.

23. The system of claim 20, wherein the image collection server is further configured for communication with a second communication network and the system further comprising an application server configured for communication with the second communication network and configured to receive the electronic representations of the plurality of images and to generate a presentation of the event based on the electronic representations of the plurality of images.

24. The system of claim 20, wherein the communication network is one from the group comprising a local area network, a metropolitan area network, the Internet, and an intranet.

25. The system of claim 20, wherein the communication network is a wireless network.
